(19) United States
(12) Patent Application Publication
(10) Pub. No.: US 2007/0253351 A1
(43) Pub. Date: Nov. 1, 2007

(54) Automatically Discovering Devices Of A Wimax Network System

(76) Inventor: Anand K. Oswal, Sunnyvale, CA (US)

Correspondence Address: BAKER BOTTS L.L.P., 2001 ROSS AVENUE, SUITE 600, DALLAS, TX, 75201-2980, US

(21) Appl. No.: 11/380,966

(22) Filed: May 1, 2006

(51) Int. Cl. H04Q 7/00

(52) U.S. Cl. 370/328; 370/401

(57) ABSTRACT

Facilitating discovery of a device in a communication network comprising a WiMax network includes the device entering the communication network. An announcement message is sent to one or more multicast groups. The announcement message announces the presence of the device to the members of the multicast groups. An operation may be performed with at least one member of the multicast groups.

### TECHNICAL FIELD

This invention relates generally to the field of communications and more specifically to automatically discovering devices of a WiMax network system.

### BACKGROUND

Devices of a communication network typically need to be aware of neighboring devices. According to some techniques, a device may be pre-configured with information about neighboring devices in order to become aware of the neighboring devices. According to other techniques, a device may use a discovery protocol in order to become aware of neighboring devices. These known techniques, however, are not efficient in certain situations. It is generally desirable to efficiently become aware of devices in certain situations.

### SUMMARY OF THE DISCLOSURE

In accordance with the present invention, disadvantages and problems associated with previous techniques for discovering networks may be reduced or eliminated.

According to one embodiment of the present invention, facilitating discovery of a device in a communication network comprising a WiMax network includes the device entering the communication network. An announcement message is sent to one or more multicast groups. The announcement message announces the presence of the device to the members of the multicast groups. An operation may be performed with at least one member of the multicast groups.

Certain embodiments of the invention may provide one or more technical advantages. A technical advantage of one embodiment may be that a device may multicast an announcement message to devices of a WiMax network to announce its presence in the network. The device may multicast the announcement message to one or more multicast groups to announce its presence to the members of the multicast groups.

A technical advantage of another embodiment may be that a base station may multicast the announcement message to a multicast group comprising the devices of an access service network. A technical advantage of yet another embodiment may be that an access service network gateway may multicast the announcement message to a first multicast group comprising the devices of the access service network. The access service network gateway may multicast the announcement message to a second multicast group comprising the gateways of the network access provider of the gateway.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 is a block diagram illustrating one embodiment of a network system in which elements may be automatically discovered;

FIG. 2 is a call flow diagram illustrating one embodiment of a method for discovering network elements that may be used with the system of FIG. 1; and

FIG. 3 is a call flow diagram illustrating another embodiment of a method for discovering network elements that may be used with the system of FIG. 1.

### DETAILED DESCRIPTION OF THE DRAWINGS

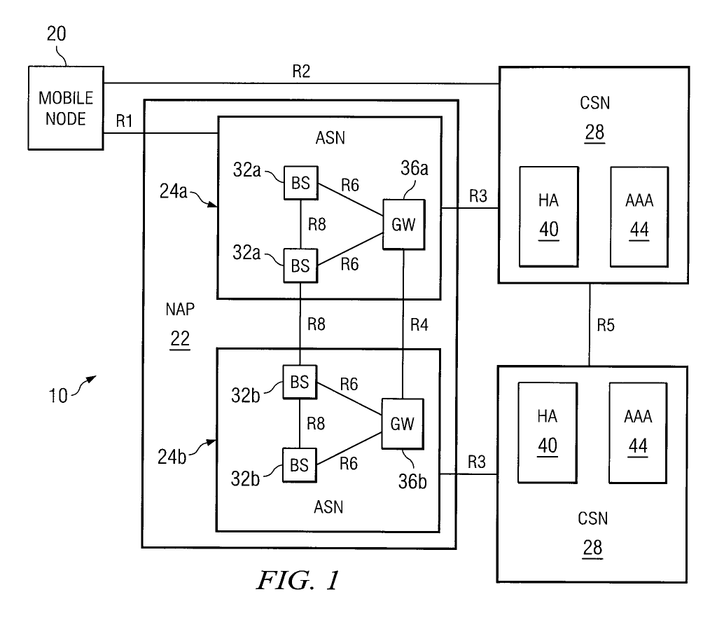

Embodiments of the present invention and its advantages are best understood by referring to FIGS. 1 through 3 of the drawings, like numerals being used for like and corresponding parts of the various drawings.

FIG. 1 is a block diagram illustrating one embodiment of a network system 10 in which devices may be automatically discovered. According to the embodiment, a device may multicast an announcement message to devices of a WiMax network to announce its presence in the network. The device may multicast the announcement message to one or more multicast groups to announce its presence to the members of the multicast groups.

According to the embodiment, a base station may multicast the announcement message to a multicast group comprising the devices of an access service network. An access service network gateway may multicast the announcement message to a first multicast group comprising the devices of the access service network. The access service network gateway may multicast the announcement message to a second multicast group comprising the gateways of the network access provider of the gateway.

According to the illustrated embodiment, system 10 operates to provide services such as communication sessions to endpoints such as mobile node 20. A communication session may refer to an active communication between endpoints, measured from endpoint to endpoint.

Information is communicated during a communication session. Information may refer to voice, data, text, audio, video, multimedia, control, signaling, other information, or any combination of the preceding. System 10 may communicate information in packets. A packet may comprise a bundle of data organized in a specific way for transmission, and a frame may comprise the payload of one or more packets organized in a specific way for transmission. A packet-based communication protocol such as Internet Protocol (IP) may be used to communicate the packets.

System 10 may utilize communication protocols and technologies to provide the communication sessions. Example communication protocols and technologies include those set by the Institute of Electrical and Electronics Engineers, Inc. (IEEE) 802.xx standards such as the 802.11 and 802.16 standards (for example, the 802.16e standards), the International Telecommunications Union (ITU-T) standards, the European Telecommunications Standards Institute (ETSI) standards, the Internet Engineering Task Force (IETF) standards, or other standards.

System 10 includes components such as devices. In general, a device may include any suitable arrangement of components operable to perform the operations of the device, and may comprise logic, an interface, memory, other component, or any suitable combination of the preceding.

“Logic” may refer to hardware, software, other logic, or any suitable combination of the preceding that may be used to provide information or instructions. Certain logic may manage the operation of a device, and may comprise, for example, a processor. “Processor” may refer to any suitable device operable to execute instructions and manipulate data to perform operations.

“Interface” may refer to logic of a device operable to receive input for the device, send output from the device, perform suitable processing of the input or output or both, or any combination of the preceding, and may comprise one or more ports, conversion software, or both. “Memory” may refer to logic operable to store and facilitate retrieval of information, and may comprise Random Access Memory (RAM), Read Only Memory (ROM), a magnetic drive, a disk drive, a Compact Disk (CD) drive, a Digital Video Disk (DVD) drive, removable media storage, any other suitable data storage medium, or a combination of any of the preceding.

According to the illustrated embodiment, system 10 includes one or more mobile nodes 20, a network access provider 22 that may operate one or more access service networks (ASNs) 24, and one or more connectivity service networks (CSNs) 28. An access service network 24 includes one or more base stations 32 and one or more gateways 36, and a connectivity service network 28 includes a home agent 40 and an authentication, authorization, and/or accounting (AAA) server 44.

According to the illustrated embodiment, mobile node 20 represents any suitable device operable to communicate with a communication system. Mobile node 20 may comprise, for example, a personal digital assistant, a computer such as a laptop, a cellular telephone, a mobile handset, or any other device operable to communicate with system 10.

Network access provider 22 may refer to an entity that provides a radio access infrastructure to one or more network service providers. For example, network access provider 22 may provide a WiMax radio access infrastructure to one or more WiMax network service providers. Network access provider 22 may operate one or more access service networks 24.

Access service network 24 represents a communication network that provides mobile node 20 access to a wired network. In general, a communication network allows devices to communicate with other devices. A communication network may comprise all or a portion of a radio access network, a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, other suitable communication link, or any combination of the preceding. According to one embodiment, access service network 24 may comprise a WiMax access service network.

Access service network 24 includes one or more base stations 32 and one or more gateways 36. A base station 32 represents any suitable device system that provides wireless services to mobile node 20 present in, or visiting, a cell of base station 32. For example, base station 24 may represent an access location that couples a wireless network, such as a wireless radio network, to a wired network, such as a wired area network. A cell may refer to a geographic unit serviced by a base station 32.

A base station 32 may comprise suitable devices operable to provide wireless services to mobile nodes 20 present in a cell. According to one embodiment, base station 32 includes a base transceiver station and a base station controller. The base transceiver station communicates signals to and from mobile node 20 through a wireless link that is typically a radio frequency link. The base station controller manages the operation of the base transceiver station.

Gateway 36 represents a device operable to manage communication among base stations 32, and may comprise a WiMax ASN gateway. Gateway 28 may provide any suitable operations. For example, gateway 28 may convert communications between different communication protocols. For example, gateway 28 may convert communications from a protocol used by network 24 to a different protocol, or vice-versa.

According to the embodiment, a device of access service network 24 may multicast announcement messages to devices of a WiMax network to announce its presence in the network. An announcement message may comprise any message suitable for announcing the presence of a device, and may include fields indicating any suitable information. According to one embodiment, an announcement message may include a device type field, a device identifier field, a services field, and a pointer field.

The device type field may indicate the device type of the announcing device. As an example, the device type may indicate that the announcing device can operate according to the WiMax protocol. The device identifier field may indicate an identifier that uniquely identifies the announcing device. As an example, the device identifier may comprise an IP address. The services field may indicate the services that may be provided by the announcing device. As an example, the announcing device may provide WiMax wireless access services. The pointer field may indicate a location where additional information about the announcing device may be found.

An announcement message may include other or additional suitable information. For example, an announcement message may include information describing logic, such as hardware or software used by the announcing device. The description may include, for example, the version of software used by the device.

According to one embodiment, the announcement message may comprise a time to live (TTL) message. A time to live message may refer to a message that is deleted after a specified period of time of after traversing a specified number of hops. The time period may be selected such that the announcement message is communicated only to neighboring devices, for example, to devices only a few hops away from the announcing device.

Multicasting may refer to the communication of packets from a single device to multiple member devices of a multicast group. The single device may send copies of packets to the member devices of the multicast group. A multicast group may refer to a set of devices to which packets are multicast. A multicast group may be represented by, for example, identifiers, such as addresses, of the members of the multicast group. A multicast group may have a group identifier that uniquely identifies the multicast group. As an example, IPv4 multicast procedures may use Class D Internet addresses.

Any suitable multicast groups may be defined. According to one embodiment, an ASN device group comprising the base stations 32 and gateways 36 of an access service network 24 may be defined. As an example, a multicast group for access service network 24a may include base stations 32a and gateway 36a, and a multicast group for access service network 24b may include base stations 32b and gateway 36b. An NAP gateway group may include the gateways 36 of a network access provider 22. As an example, a ASN gateway group may include gateways 36a and 36b.

According to one embodiment, base station 32 may multicast an announcement message to a multicast group to announce its presence. The message may be multicast at any suitable time, for example, when base station 32 becomes operable to perform its operations in system 10. The message may be multicast to any suitable multicast group, for example, to the ASN devices group.

The devices that receive the announcement message become aware of the announcing base station 32, and may then communicate with the announcing base station 32 to perform any suitable operation. As an example, gateway 36 may communicate with the announcing base station 32 to allow base station 32 to register with gateway 36. As another example, other base stations 32 may communicate with the announcing base station 32 to generate a mesh network. As another example, the announcing base station 32 may download network information from gateway 36. Network information may include, for example, configuration information, network topology information, image information, other information, or any combination of the preceding.

According to the embodiment, gateway 36 may multicast an announcement message to a multicast group to announce its presence. The message may be multicast to any suitable multicast group. For example, gateway 36a may multicast the announcement message to an NAP gateway group that includes gateways 36 of NAP 22. As another example, gateway 36a may multicast the announcement message to an ASN devices group that includes base stations 32a and gateway 36a.

Connectivity service network 28 represents a communication network that provides mobility management for mobile node 20. Connectivity service network 28 may also provide other operations, for example, authorization operations, host configuration management operations, other operation, or any combination of the preceding.

Connectivity service network 28 may be provided by a network service provider. A network service provider may refer to an entity that provides IP connectivity and WiMAX services to subscribers.

Connectivity service network 28 includes home agent 40 and AAA server 44. A home agent 40 of a mobile node 20 may represent an agent that allocates the address of mobile node 20 and forwards packets to mobile node 20. AAA server 44 may represent any suitable device operable to provide AAA-related services. AAA-related services may include services for authentication, authorization, accounting, or any suitable combination of the preceding. Authentication may refer to validating the identity of mobile node 20. Authorization may refer to authorizing a level of service for mobile node 20. Accounting may refer to tracking the usage of resources. As an example, an authorization server may provide one, two, or three of the listed services.

Modifications, additions, or omissions may be made to system 10 without departing from the scope of the invention. The components of system 10 may be integrated or separated according to particular needs. Moreover, the operations of system 10 may be performed by more, fewer, or other modules. Additionally, the operations of system 10 may be performed using any suitable logic. As used in this document, “each” refers to each member of a set or each member of a subset of the set.

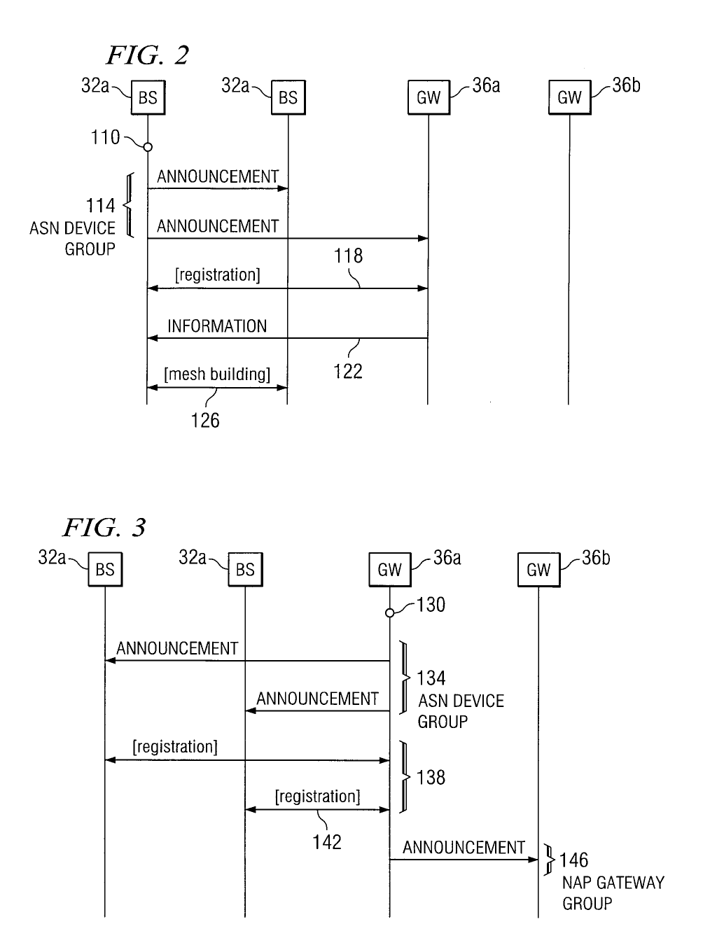

FIG. 2 is a call flow diagram illustrating one embodiment of a method for discovering network devices that may be used with system 10 of FIG. 1. The method begins at step 110, where the announcing base station 32a enters network system 10. Base station 32a announces its presence by sending announcement messages to an ASN device group at step 114. The ASN device group includes the devices of access service network 24a, such as the other base station 32a and gateway 36a.

The other base station 32a and gateway 36a are aware of the announcing base station's presence and can now communicate to perform operations. The announcing base station 32a and gateway 36a perform a registration procedure at step 118. The announcing base station 32a downloads network information from gateway 36a at step 122. The network information may allow base station 32 to communicate within access service network 24a. Base stations 32a may also perform mesh building operations at step 126. After performing the operations, the method terminates.

Modifications, additions, or omissions may be made to the method without departing from the scope of the invention. The method may include more, fewer, or other steps. Additionally, steps may be performed in any suitable order without departing from the scope of the invention.

FIG. 3 is a call flow diagram illustrating another embodiment of a method for discovering network devices that may be used with system 10 of FIG. 1. The method begins at step 130, where gateway 36a enters network system 10. Gateway 36a announces its presence to the devices of access service network 24a by sending an announcement message to an ASN device group. According to the embodiment, the ASN device group includes base stations 32a and gateway 36a.

The devices of access service network 24a become aware of gateway 36a when they receive the announcement message, and may communicate with gateway 36a to perform operations. A registration operation may be performed at step 138.

Gateway 36a announces its presence to other gateways 36b of network access provider 22 at step 146 by sending an announcement message to an NAP gateway group that includes gateways 36a and 36b. When gateway 36b becomes aware of the presence of gateway 36a, gateway 36b may communicate with gateway 36a to perform operations, such as downloading information. Alternatively, gateway 36b may just maintain the presence information. After sending the announcement message, the method terminates.

Modifications, additions, or omissions may be made to the method without departing from the scope of the invention. The method may include more, fewer, or other steps. Additionally, steps may be performed in any suitable order without departing from the scope of the invention.

Certain embodiments of the invention may provide one or more technical advantages. A technical advantage of one embodiment may be that a device may multicast an announcement message to devices of a WiMax network to announce its presence in the network. The device may multicast the announcement message to one or more multicast groups to announce its presence to the members of the multicast groups.

A technical advantage of another embodiment may be that a base station may multicast the announcement message to a multicast group comprising the devices of an access service network. A technical advantage of yet another embodiment may be that an access service network gateway may multicast the announcement message to a first multicast group comprising the devices of the access service network. The access service network gateway may multicast the announcement message to a second multicast group comprising the gateways of the network access provider of the gateway.

While this disclosure has been described in terms of certain embodiments and generally associated methods, alterations and permutations of the embodiments and methods will be apparent to those skilled in the art. Accordingly, the above description of example embodiments does not constrain this disclosure. Other changes, substitutions, and alterations are also possible without departing from the spirit and scope of this disclosure, as defined by the following claims.

What is claimed is:

1. A method for facilitating discovery of a device in a communication network, comprising:
entering a communication network as a device of the communication network, the communication network comprising a WiMax network; and
sending an announcement message to one or more multicast groups, a multicast group of the one or more multicast groups comprising a plurality of members, the announcement message announcing the presence of the device to the members of the one or more multicast groups.

2. The method of claim 1, wherein:
the device comprises a base station of an access service network of the communications system; and
the plurality of members of a multicast group of the one or more multicast groups further comprises:
one or more gateways of the access service network; and
one or more base stations of the access service network.

3. The method of claim 1, wherein:
the device comprises a gateway of a network access provider; and
the plurality of members of a multicast group of the one or more multicast groups further comprises a plurality of gateways of the network access provider.

4. The method of claim 1, wherein the announcement message comprises a time to live message.

5. The method of claim 1, further comprising:
performing an operation with at least one member of the one or more multicast groups.

6. The method of claim 5, wherein performing an operation with at least one member of the one or more multicast groups further comprises:
performing a registration operation.

7. The method of claim 5, wherein performing an operation with at least one member of the one or more multicast groups further comprises:
downloading network information.

8. A device in a communication network, comprising logic operable to:
enter a communication network as a device of the communication network, the communication network comprising a WiMax network; and
send an announcement message to one or more multicast groups, a multicast group of the one or more multicast groups comprising a plurality of members, the announcement message announcing the presence of the device to the members of the one or more multicast groups.

9. The device of claim 8, wherein:
the device comprises a base station of an access service network of the communications system; and
the plurality of members of a multicast group of the one or more multicast groups further comprises:
one or more gateways of the access service network; and
one or more base stations of the access service network.

10. The device of claim 8, wherein:
the device comprises a gateway of a network access provider; and
the plurality of members of a multicast group of the one or more multicast groups further comprises a plurality of gateways of the network access provider.

11. The device of claim 8, wherein the announcement message comprises a time to live message.

12. The device of claim 8, the logic further operable to:
perform an operation with at least one member of the one or more multicast groups.

13. The device of claim 12, the logic further operable to perform an operation with at least one member of the one or more multicast groups by:
performing a registration operation.

14. The device of claim 12, the logic further operable to perform an operation with at least one member of the one or more multicast groups by:
downloading network information.

15. A system for facilitating discovery of a device in a communication network, comprising:
at least one member of a multicast group comprising a plurality of members; and
a device operable to:
enter a communication network as a device of the communication network, the communication network comprising a WiMax network;
send an announcement message to one or more multicast groups, a multicast group of the one or more multicast groups comprising a plurality of members, the announcement message announcing the presence of the device to the members of the one or more multicast groups.

16. The system of claim 15, wherein:
the device comprises a base station of an access service network of the communications system; and
the plurality of members of a multicast group of the one or more multicast groups further comprises:
one or more gateways of the access service network; and
one or more base stations of the access service network.

17. The system of claim 15, wherein:
the device comprises a gateway of a network access provider; and
the plurality of members of a multicast group of the one or more multicast groups further comprises a plurality of gateways of the network access provider.

18. The system of claim 15, wherein the announcement message comprises a time to live message.

19. The system of claim 15, the device further operable to:
perform an operation with the at least one member of the one or more multicast groups.

20. The system of claim 19, the device further operable to perform an operation with the at least one member of the one or more multicast groups by:
performing a registration operation.

21. The system of claim 19, the device further operable to perform an operation with the at least one member of the one or more multicast groups by:
downloading network information.

22. The system of claim 15, wherein:
the device comprises at least one of:
a base station of an access service network of the communications system; and
the device comprises a gateway of a network access provider;
the plurality of members of a multicast group of the one or more multicast groups further comprises at least one of:
one or more gateways of the access service network;
one or more base stations of the access service network; and
a plurality of gateways of the network access provider;
the announcement message comprises a time to live message; and
the device is further operable to perform an operation with the at least one member of the one or more multicast groups by:
performing a registration operation; and
downloading network information.

23. A system for facilitating discovery of a device in a communication network, comprising:
means for entering a communication network as a device of the communication network, the communication network comprising a WiMax network; and
means for sending an announcement message to one or more multicast groups, a multicast group of the one or more multicast groups comprising a plurality of members, the announcement message announcing the presence of the device to the members of the one or more multicast groups.
